(19) United States
(12) Patent Application Publication
(10) Pub. No.: US 2023/0041618 A1
(43) Pub. Date: Feb. 9, 2023

(54) DEVICE FOR MOUNTING CROSS BEAM IN BASE STATION ANTENNA

(71) Applicant: CommScope Technologies LLC., Hickory, NC (US)

(72) Inventors: Shital Sawanta Udagave, Salcette (IN); Shrikrishna Ghadi, Salcette (IN)

(21) Appl. No.: 17/862,809

(22) Filed: Jul. 12, 2022

(30) Foreign Application Priority Data
Jul. 22, 2021 (IN) 202121032986

(51) Int. Cl. H01Q 1/24; H01Q 19/17; H01Q 21/00

(52) U.S. Cl. CPC H01Q 1/246; H01Q 19/17; H01Q 21/0087

(57) ABSTRACT

A device for mounting a cross beam in a base station antenna is provided. The device comprises a first knob formed on a first wall of the device, the first knob comprising a first shaft portion and a first head portion. The device further comprises a second knob formed on a second wall of the device, the second wall is arranged adjacent to the first wall. the second knob comprising a second shaft portion and a second head portion. The first shaft portion of the first knob is adapted to be received in a keyhole defined in the cross beam of base station antenna. The second shaft portion of the second knob in adapted to be received in a first slot defined in a reflector of base station antenna. The device eliminates requirement of hardware elements such as bolts, washers etc to mount cross beam in base station antenna.

### RELATED APPLICATION

The present application claims priority from and the benefit of Indian Patent Application No. 202121032986, filed Jul. 22, 2021, the disclosure of which is hereby incorporated by reference herein in its entirety.

### TECHNICAL FIELD

The disclosure relates to communication systems and, in particular, to a device for mounting a cross beam on a reflector in a base station antenna.

### BACKGROUND

The information in this section merely provides background information related to the present disclosure and may not constitute prior art(s) for the present disclosure.

Cellular communications systems are used to provide wireless communications to fixed and mobile subscribers (herein “users”). A cellular communications system may include a plurality of base stations that each provide wireless cellular service for a specified coverage area that is typically referred to as a “cell”. Each base station may include one or more base station antennas that are used to transmit radio frequency (“RF”) signals to, and receive RF signals from, the users that are within the cell served by the base station. Base station antennas are directional devices that can concentrate the RF energy that is transmitted in certain directions (or received from those directions). A cellular base station antenna is the most critical consideration in an efficient cellular network, and it all depends on choosing the antenna with exactly the right physical characteristics for a specific application.

Most base station antennas comprise one or more linear or planar arrays of radiating elements that are mounted on a flat panel reflector assembly. The reflector assembly or the reflector may serve as a ground plane for disposing the radiating elements thereon and may also reflect RF energy that is emitted rearwardly by the radiating elements back in the forward direction. The reflector is configured to provide provisions for mounting multiple cross beams and/or metal parts of the base station antenna. The cross beams mounted on the reflector facilitate positioning additional components, for example, phase shifters, decoupling structures, radiating elements etc in the base station antenna and provide strength to the reflector. The cross beams are generally mounted with the reflector using fasteners.

More recently, different mounting means are utilized to mount the cross beams with the reflector in base station antennas. The cross beams and/or different metal parts are connected to a reflector side wall or a reflector choke using metal hardware elements or clips with the help of nuts, bolts, washers and likewise. The utilization of said hardware elements increases complexity in assembling or dis-assembling of the cross beams or other metal parts from the reflector. Furthermore, dedicated hardware elements are required for mounting the cross beams to the reflectors of different thickness. The utilization of plurality of hardware elements also increases an overall cost of the base station antenna including the manufacturing cost, assembling cost and material cost.

Accordingly, there remains a need of economic yet sustainable mounting elements for mounting the cross beams to reflectors in base station antennas.

### SUMMARY

The one or more shortcomings of the prior art are overcome by the mounting element as claimed, and additional advantages are provided through the provision of the mounting element as claimed in the present disclosure. Additional features and advantages are realized through the techniques of the present disclosure. Other embodiments and aspects of the disclosure are described in detail herein and are considered a part of the claimed disclosure.

Pursuant to the embodiments of the present disclosure, in an aspect, a device for mounting a cross beam in a base station antenna is provided. The device comprises a first knob formed on a first wall of the device, the first knob comprising a first shaft portion and a first head portion. The device further comprises a second knob formed on a second wall of the device, the second wall is arranged adjacent to the first wall, the second knob comprising a second shaft portion and a second head portion. The first shaft portion of the first knob is adapted to be received in a keyhole defined in the cross beam of the base station antenna. The second shaft portion of the second knob in adapted to be received in a first slot defined in a reflector of the base station antenna.

In another non-limiting embodiment of the present disclosure, a size of the first head portion is more than a size of the first shaft portion of the first knob.

In another non-limiting embodiment of the present disclosure, a size of the second head portion is more than a size of the second shaft portion of the second knob.

In another non-limiting embodiment of the present disclosure, the first head portion of the first knob is defined with a rib.

In another non-limiting embodiment of the present disclosure, the device comprises a third knob formed on a third wall of the device, the third wall is arranged adjacent to the first wall.

In another non-limiting embodiment of the present disclosure, the second wall and the third wall are interconnected by the first wall to form a unitary structure.

In another non-limiting embodiment of the present disclosure, the third knob is defined with a third shaft portion and a third head portion. A size of the third head portion is more than a size of the third shaft portion.

In another non-limiting embodiment of the present disclosure, a length of the third shaft portion of the third knob is more than a length of the second shaft portion of the second knob.

In another non-limiting embodiment of the present disclosure, a length of each of the second shaft portion and the third shaft portion of the second knob and the third knob, respectively, is at least equal to a thickness of the reflector.

In another non-limiting embodiment of the present disclosure, at least one of the second wall and the third wall comprises one or more legs extending from the corresponding of the second wall or the third wall of the device, the at least one leg adapted to be received in a second slot defined adjacent to the first slot in the reflector.

In another non-limiting embodiment of the present disclosure, the device is manufactured by an injection moulding process to have a unitary structure.

In another non-limiting embodiment of the present disclosure, the device is manufactured from a polymer material having high tensile strength.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 is a perspective view of a reflector assembly, in accordance with an embodiment of the present disclosure;

FIG. 2 is a perspective view of a device for use with the reflector assembly of FIG. 1, in accordance with a first embodiment of the present disclosure:

FIG. 3 is a front view of the device of FIG. 2, in accordance with an embodiment of the present disclosure;

FIG. 4 is a side view of the device of FIG. 2, in accordance with an embodiment of the present disclosure;

FIG. 5 is a partial perspective view of a reflector of the reflector assembly of FIG. 1, in accordance with an embodiment of the present disclosure;

FIG. 6 is a top view of the reflector assembly of FIG. 1, in accordance with an embodiment of the present disclosure:

FIG. 7 is a cross-sectional view of the reflector assembly of FIG. 6, taken along the line A-A, in accordance with an embodiment of the present disclosure;

FIG. 8 is an enlarged cross-sectional view of a portion B of the reflector assembly of FIG. 7, in accordance with an embodiment of the present disclosure;

FIG. 9 is a perspective view of a device for mounting the cross beam on the reflector, in accordance with a second embodiment of the present disclosure:

FIG. 10 is a front view of the device of FIG. 9, in accordance with an embodiment of the present disclosure:

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present disclosure.

### DETAILED DESCRIPTION

While the disclosure is susceptible to various modifications and alternative forms, specific embodiments thereof have been shown by way of example in the FIGS. and will be described in detail below. It should be understood, however that it is not intended to limit the disclosure to the particular forms disclosed, but on the contrary, the disclosure is to cover all modifications, equivalents, and alternatives falling within the scope of the disclosure as defined by the appended claims.

Before describing detailed embodiments, it may be observed that the novelty and inventive step that are in accordance with the present disclosure resides in a device for mounting a cross beam on a reflector of a base station antenna. It is to be noted that a person skilled in the art can be motivated from the present disclosure and modify the various constructions of the device of base station antenna and the steps of performing the method of the present disclosure. However, such modification should be construed within the scope of the present disclosure. Accordingly, the drawings are showing only those specific details that are pertinent to understanding the embodiments of the present disclosure so as not to obscure the disclosure with details that will be readily apparent to those of ordinary skill in the art having benefit of the description herein.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusions, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

The terms like “at least one” and “one or more” may be used interchangeably or in combination throughout the description.

The device described in the present disclosure is configured to mount a cross beam with a reflector of the base station antenna (hereinafter referred to as “antenna”); when compared to the existing systems, the device eliminates the requirement of hardware elements for example: bolts, nuts, washers and the likewise, reducing the number of components that the installer needs to loosen i.e. by eliminating the requirement of said components, for example: nuts, bolts, screws etc, and thus, reducing an overall cost of the antenna. Furthermore, according to one embodiment of the present disclosure, the device may be utilized to mount the cross beam with reflectors having different thickness. The device thus reduces the requirement of dedicated fastening or mounting means for mounting the cross beam with the reflectors of different thickness. The device is defined having a unitary structure which is manufactured from molding processes, for example: injection molding process and the likewise. However, different forming processes may be utilized to form a unitary structure of the device, in accordance with the present disclosure.

Pursuant to embodiments of the present disclosure, a device for mounting a cross beam in a base station antenna is provided. The device comprises a first knob formed on a first wall of the device, the first knob comprising a first shaft portion and a first head portion. The device further comprises a second knob formed on a second wall of the device, the second wall is arranged adjacent to the first wall, the second knob comprising a second shaft portion and a second head portion. The first shaft portion of the first knob is adapted to be received in a keyhole defined in the cross beam of the base station antenna. The second shaft portion of the second knob in adapted to be received in a first slot defined in a reflector of the base station antenna.

In an embodiment, a size of the first head portion is more than a size of the first shaft portion of the first knob.

In accordance with further embodiments, a size of the second head portion is more than a size of the second shaft portion of the second knob.

In an embodiment, the first head portion of the first knob is defined with a rib.

Further, in an embodiment, the device comprises a third knob formed on a third wall of the device, the third wall is arranged adjacent to the first wall.

Furthermore, in an embodiment, the second wall and the third wall are interconnected by the first wall to form a unitary structure.

In an embodiment, the third knob is defined with a third shaft portion and a third head portion. A size of the third head portion is more than a size of the third shaft portion.

In an embodiment, a length of the third shaft portion of the third knob is more than a length of the second shaft portion of the second knob.

In an embodiment, a length of each of the second shaft portion and the third shaft portion of the second knob and the third knob, respectively, is at least equal to a thickness of the reflector.

In an embodiment, at least one of the second wall and the third wall comprises one or more legs extending from the corresponding of the second wall or the third wall of the device, the at least one leg adapted to be received in a second slot defined adjacent to the first slot in the reflector.

In an embodiment, the keyhole is provided at opposite ends in the cross beam of the base station antenna

In an embodiment, the device is manufactured by an injection moulding process to have a unitary structure.

In an embodiment, the device is manufactured from a polymer material having high tensile strength.

Reference will now be made to the exemplary embodiments of the disclosure, as illustrated in the accompanying drawings. Wherever possible same numerals will be used to refer to the same or like parts.

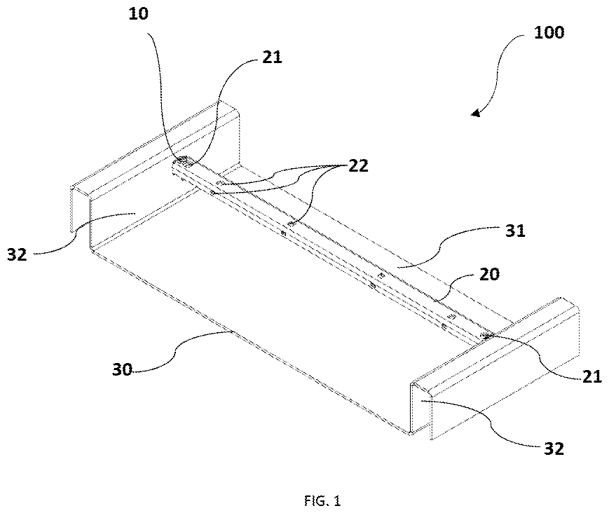

Embodiments of the disclosure are described in the following paragraphs with reference to FIGS. 1 to 10. In FIGS. 1 to 10, the same element or elements which have same functions are indicated by the same reference signs.

FIG. 1 is a perspective view of a reflector assembly 100 comprises, among other elements, a device 10 for mounting one or more cross beams 20 on a reflector 30. The reflector 30 has a bottom plate 31 and a pair of side plates 32. The pair of side plates 32 are extending from the bottom plate 31 along a length of the reflector 30. The reflector 30 may comprise a sheet of metal, such as ahuninium and the bottom plate 31 thereof may serve as a main reflective surface that reflects radiofrequency (RF) energy. The reflector 30 may comprise of various openings to facilitate mounting of various elements, for example, the radiating elements, feed boards, decoupling structures, isolation structures and/or structural supports or cross beams. Each of the pair of side plates 32 are laterally extending from opposite edges of the bottom plate 31 of the reflector. According to an exemplary embodiment of the present disclosure, the side plates 32 have a U-shaped channel that extends along the length of the reflector 30 and serve as RF chokes. An RF choke is a circuit element that allows some currents to pass, but which is designed to block or “choke” currents in certain frequency bands. The reflector 30 for a base station antenna (not shown in FIGS.), may be formed from the sheet metal material having high reflectance.

The reflector 30 may provide provisions for mounting one or more cross beams 20, as shown in FIG. 1. FIG. 1 depicts only one cross beam 20 mounted between the side plates 32 of the reflector 30. The cross beam 20 is mounted to provide strength to the reflector 30 and is configured to provide provisions for fixing other elements of the base station antenna. The cross beam 20 may be defined as a longitudinal plate placed transverse to the side plates 32 of the reflector 30 and parallel to the bottom plate 31 of the reflector 30. Each end of the cross beam 20 is provided with at least one slot to receive the device 10 in order to facilitate mounting of the cross beam 20 to a side wall 32 of the reflector 30. The shape of the slot provided on the cross beam 20 is determined such that the device 10 gets locked to the cross beam 10 without implementing any hardware elements such as, for example, bolts, screws, nuts, washers and the likewise. In an exemplary embodiment of the present disclosure, the cross beam 20 is defined with a pair of keyholes 21 positioned at opposite ends of the cross beam 20 to receive the device 10. The keyholes 21 may comprise a circular slot integrated with a rectangular slot providing a keyhole shaped profile. The cross beam 20 may comprise of plurality of apertures 22 on longitudinal and lateral surfaces to facilitate reduction in weight of the cross beam 20, which in turn reduces weight of the entire reflector assembly 100. The plurality of apertures 22 also reduce amount of material for manufacturing the cross beam 20, lowering the manufacturing cost thereof.

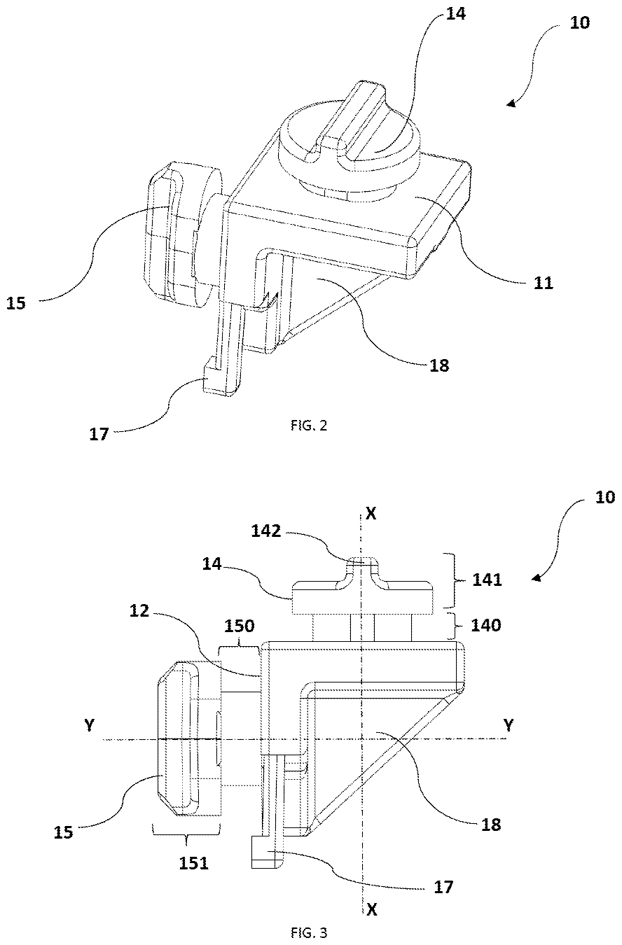

According to an exemplary embodiment of the present disclosure, the device 10 for mounting the cross beam 20 to the reflector 30 of the base station antenna comprises a first wall 11 and a second wall 12. Referring to FIGS. 2-4, the first wall 11 and the second wall 12 are adjacent to each other. According to an exemplary embodiment of the present disclosure, the first wall 11 extends transversely from an edge of the second wall 12. Alternatively, the first wall 11 may extend at any angle with respect to the second wall 12 to facilitate mounting of the cross beam 20 at a desired inclination with respect to the side wall 32 of the reflector 30. The device 10 may comprise an integral wedge portion 18 connecting the first wall 11 with the second wall 12. The wedge portion 18 provides strength to the first wall 11 and the second wall 12 of the device 10. Further, the wedge portion 18 prevents deformation (for example, bending of the first wall 11 towards the second wall 12), when other elements are mounted to the cross beam 20. The first wall 11 and the second wall 12 may be formed in any shape. The first wall 11 and the second wall 12 are formed having a rectangle-shaped profile, in accordance with an exemplary embodiment of the present disclosure. Each of the first wall 11 and the second wall 12 is having an outer surface, such that at least one knob is provided to extend transversely from said outer surface.

The first wall 11 of the device 10 is having a first knob 14 extending along a vertical axis X-X. The vertical axis X-X is defined as an axis passing through a centre of the first wall 11, as shown in FIG. 3. The first knob 14 is having a profile such that the first knob 14 is configured to be received in a keyhole 21 defined in the cross beam 20 and is configured to get locked with the cross beam 20 when a push force is applied on the first knob 14. According to an exemplary embodiment of the present disclosure, the knob 14 is defined with a first shaft portion 140 and a first head portion 141. The first shaft portion 140 extends from the outer surface of the first wall 11.

The first head portion 141 is formed at a free end of the first shaft portion 140. The first shaft portion 140 may be defined with a cylindrical profile, but not limited to the same. A size of the first head portion 141 is more than a size of the first shaft portion 140. The first shaft portion 140 is defined having a length measured from the outer surface of the first wall 11 to the first head portion 141. The length of the first shaft portion 140 is pre-determined based on a thickness of the cross beam 20. The length of the first shaft portion 140 of the first knob 14 is determined such that the cross beam 20 fits in between the first head portion 141 of the first knob 14 and the outer surface of the first wall 11 of the device 10. According to an embodiment of the present disclosure, the length of the first shaft portion 140 is at least equal to the thickness of the cross beam 20.

The first head portion 141 of the knob 14 is defined having a rib 142 extending in an upward direction along the vertical axis X-X. The first head portion 141 of the knob may be defined having a size more than a size of the shaft portion 140 of the knob 14. According to an exemplary embodiment, the first head portion 141 is defined having a circumference more than a circumference of the shaft portion 140 of the knob 14. The circumference of the first head portion 141 facilitates locking of the device 10 with the cross beam 20, once the first knob 14 is received in the rectangular slot of the keyhole 21 of the cross beam 20. The first head portion 141 abuts against the longitudinal surface of the cross beam 20, preventing a vertical displacement of the cross beam 20 with respect to the knob 10.

According to an embodiment of the present disclosure, the first head portion 141 is defined having a circular profile which is initially received in the circular slot of the keyhole 21 in the cross beam 20. The circular profile of the head portion 141 may be defined having a cross section more than a cross section of the first shaft portion 140. The rib 142 extending from the first head portion 141 may be defined having a rectangular profile to provide maximum surface for the user's finger to push the device 10 into the rectangular slot of the keyhole 21 in the cross beam 20.

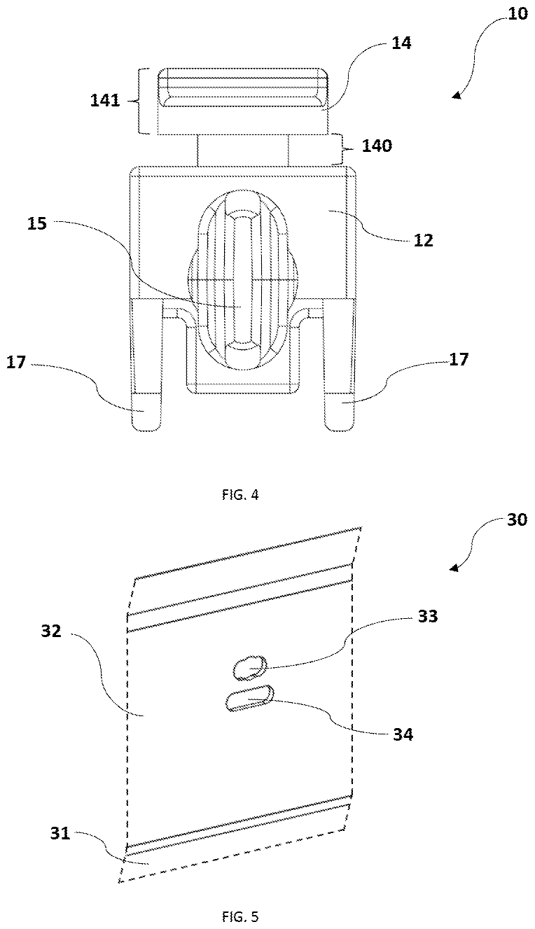

The second wall 12 of the device 10 is having a second knob 15 extending laterally from the outer surface of the second wall 12, along a horizontal axis Y-Y. The horizontal axis Y-Y is defined as an axis passing through centre of the second wall 12 and intersects perpendicularly with the vertical axis X-X, as shown in FIG. 3. The second knob 15 is defined having a second shaft portion 150 and a second head portion 151. The second head portion 151 is oriented orthogonal to the first head portion 141. A size of the second head portion 151 is more than a size of the second shaft portion 150. The second head portion 151 may comprise a rib like member to provide strength the second knob 15 of the device 10. The second wall 12 of the device 10 comprises at least one leg 17 extending from a bottom surface of the second wall 12. The leg 17 is configured to limit abrupt or unintentional movement of the device 10 mounted to the reflector 30. According to an exemplary embodiment, the device 10 is defined having two legs 17 extending from the second wall 12 of the device 10, as shown in FIG. 4.

According to an exemplary embodiment of the present disclosure, the second shaft portion 150 is defined having a length measured from the outer surface of the second wall 12 to the second head portion 151 of the knob 15. The length of the second shaft portion 150 is predetermined based on a thickness of the side wall 32 of the reflector 30 to which the device 10 is configured to be mounted. The length of the second shaft portion 150 is determined such that the side wall 32 fits in between the second head portion 151 and the outer surface of the second wall 12. According to an embodiment of the present disclosure, the length of the second shaft portion 150 of the second knob 15 is at least equal to the thickness of the side wall 32 of the reflector 30.

FIG. 5 is a partial perspective view of the reflector 30, in accordance with an exemplary embodiment of the present disclosure. The reflector 30 comprising the pair of side walls 32 having a first slot 33 and a second slot 34 disposed adjacent to each other. The first slot 33 is adapted to receive the second head portion 151 of the second knob 15, such that the knob 15 is insertable into the first slot 33. The first slot 33 is having a profile such that the second head portion 151 of the second knob 15 gets locked with the side wall 32 of the reflector 30 when a rotational movement is applied to the device 10. According to an embodiment of the present disclosure, the second slot 33 is having an elliptical profile consistent with an elliptical profile of the second head portion 151 of the second knob 15. The second slot 34 is formed below the first slot 33, such that the second slot 34 is adapted to receive the at least one leg 17 extending from the second wall 12 of the device 10. The second slot 34 is defined having an elliptical profile, but not limited to the same and may be formed in any shape to receive the at least one leg 17. The at least one leg 17 is received in the second slot 34 is a snap-fit manner, preventing utilization of any hardware elements to lock the device 10 with the side wall 32 of the reflector 30.

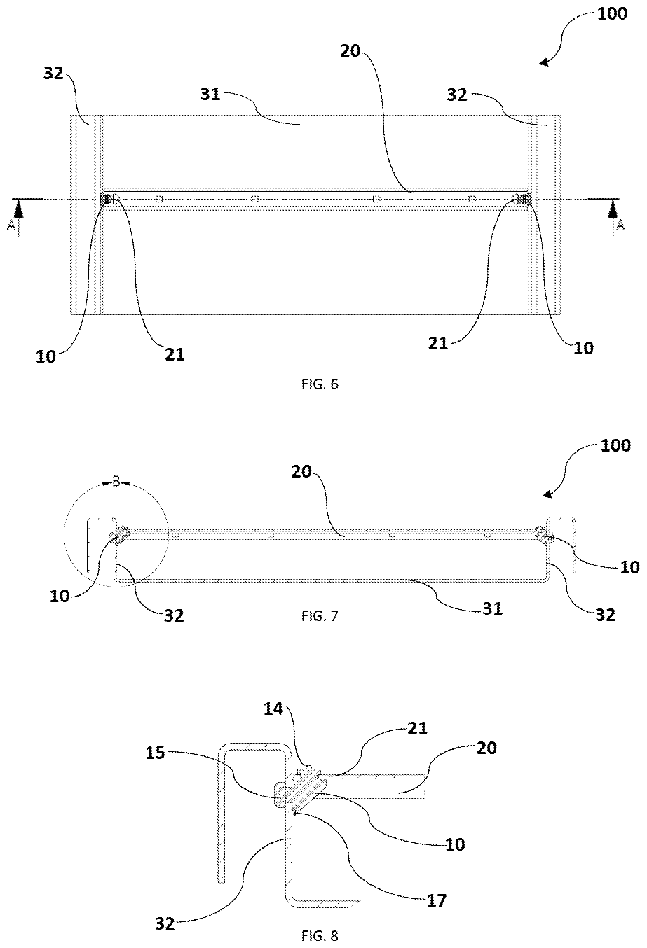

According to an embodiment of the present disclosure, a method for mounting a cross beam 20 to a reflector 30 by a device 10 is described. The method comprises the steps of mounting the cross beam 20 to one of a pair of side walls 32 of the reflector 30 by the device 10. The same method steps may be implemented to mount the cross beam 20 to another side wall 32 of the reflector 30 by another device 10. Referring to FIGS. 6-8, the reflector assembly 100 comprising the cross beam 20 mounted to the reflector 30 by the device 10 is depicted. The method comprises a first step of inserting a first knob 14 of the device 10 into a keyhole 21 formed in the cross beam 20. The cross beam 20 fitted with the device 10 at is configured to place in between the pair of side walls 32 of the reflector 30, such that a second head portion 151 of a second knob 15 provided on a second wall 12 of the device 10 gets aligned with a first slot 33 formed on the side wall 32 of the reflector 30. Once the second head portion 151 of the second knob 15 is aligned with the first slot 33, a push force is applied on a rib 142 formed on the first head portion 141 of the first knob 14. The application of push force facilitates locking of the first knob 14 with the cross beam 20 and at the same time facilitates insertion of the second head portion 151 into the first slot 33 on the side wall 32 of the reflector 30. In the next step, a rotary moment is applied to the cross beam 10, which in turn also rotates the device 10 mounted to the cross beam 20. The rotary movement of the device 10 with the cross beam 20 facilitates the second head portion 151 of the second knob 15 of the device 10 to abut against a surface of the side wall 32 of the reflector 30 and at the same time facilitates insertion of at least one leg 17 into a second slot 33 formed on the side wall 32 of the reflector 30.

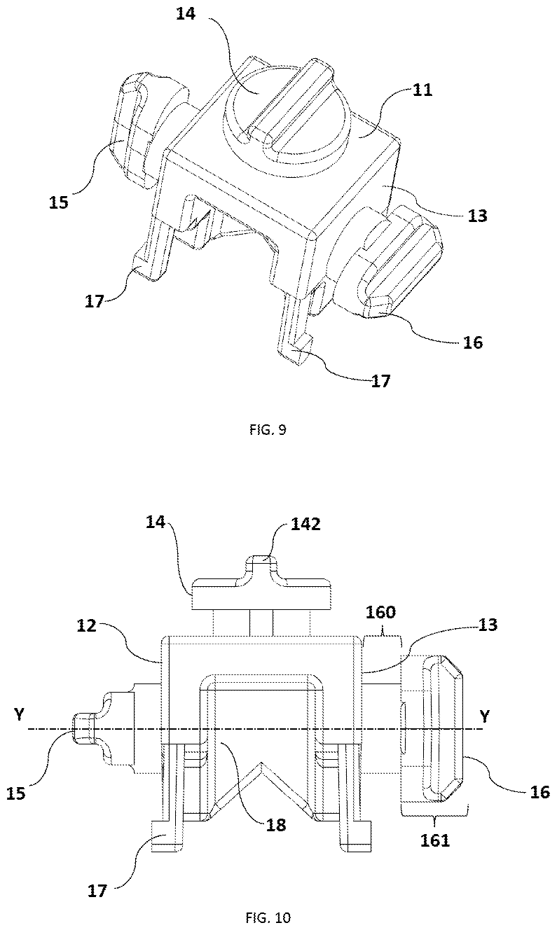

According to another embodiment of the present disclosure, a device 10 comprises a third wall 13 extending orthogonal to the first wall 11, as shown in FIGS. 9-10. The third wall 13 is defined with a third knob 16 extending from an outer surface of the third wall 13, along the horizontal axis Y-Y. The third knob 16 includes a third shaft portion 160 and a third head portion 161. The third knob 16 may be defined with a rib extending from the third head portion 161 to provide strength to the third knob 16. A size of the third head portion 161 is more than a size of the third shaft portion 160. The third shaft portion 160 is defined having a length measured from the outer surface of third wall 13 to the third head portion 161. The length of the third shaft portion 160 is pre-determined based on the thickness of the reflector 30 or reflector side wall 32. The length of the third shaft portion 160 more than the length of the second shaft portion 150 to facilitate utilization of the single device 10 for mounting the cross beam 20 to reflectors 30 of different thickness. The third head portion 161 may be oriented orthogonal to the second head portion 151 to facilitate ease in selection of the correct knob 15, 16 to be mounted to the reflector 30, the selection is based on the thickness of the reflector 30. The third wall 13 of the device 10 comprises at least one leg 17 extending from bottom surface of the third wall 13 to facilitate locking of the device 10 with the side wall 32 of the reflector 30. The second wall 12 and the third wall 13 of the device 10 is interconnected by a first wall 11 to form a unitary structure.

The device 10 may be formed through an injection moulding process to form a unitary structure. However, the device may also be formed through other forming processes like—3D printing process and likewise to form a unitary structure with lesser defects. The device 10 may be formed from any polymer material having high tensile strength. According to an exemplary embodiment of the present disclosure, the device 10 is formed from a nylon or ABS material possessing high tensile strength.

In an embodiment of the present disclosure, the device for mounting cross beam of the base station antenna to the reflector do not require any hardware elements for example: nuts, bolts, washers etc. The utilization of said device reduces the hardware inventory to mount the cross beam with the reflector.

In an embodiment of the present disclosure, the utilization of device for mounting purpose reduces an overall cost of the base station antenna, including the manufacturing cost, assembling cost and maintenance cost.

In an embodiment of the present disclosure, the device utilizes a press fit mechanism to reduce mounting time of the cross beam with the reflector.

In an embodiment of the present disclosure, the same device may be utilized to facilitate mounting of the cross beam with the reflector having different reflector or side wall thickness.

The various embodiments of the present disclosure have been described above with reference to the accompanying drawings. The present disclosure is not limited to the illustrated embodiments; rather, these embodiments are intended to fully and completely disclose the subject matter of the disclosure to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the figures is turned over, elements described as “under” or “beneath” other elements or features would then be oriented “over” the other elements or features. Thus, the exemplary term“under” can encompass both an orientation of over and under. The device may be otherwise oriented (rotated 90 degrees or at other orientations) and the spatially relative descriptors used herein interpreted accordingly.

Herein, the terms “attached”, “connected”. “interconnected”, “contacting”, “mounted”, “coupled” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising”, “includes” and % or “including” when used in this specification, specify the presence of stated features, operations, elements, and/or components, but do not preclude the presence or addition of one or more other features, operations, elements, components, and/or groups thereof.

While considerable emphasis has been placed herein on the particular features of this disclosure, it will be appreciated that various modifications can be made and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

| PARTICULARS | REFERRAL NUMERAL |
|---|---|
| Reflector assembly | 100 |
| Device | 10 |
| First wall of device | 11 |
| Second wall of device | 12 |
| Third wall of device | 13 |
| First knob | 14 |
| First shaft portion | 140 |
| First head portion | 141 |
| Rib | 142 |
| Second knob | 15 |
| Second shaft portion | 150 |
| Second head portion | 151 |
| Third knob | 16 |
| Third shaft portion | 160 |
| Third head portion | 161 |
| Leg | 17 |
| Wedge portion | 18 |
| Cross beam | 20 |
| Keyhole | 21 |
| Apertures | 22 |
| Reflector | 30 |
| Bottom plate | 31 |
| Pair of side plates | 32 |
| First slot | 33 |
| Second slot | 34 |

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

We claim:

1. A device for mounting a cross beam in a base station antenna, the device comprising:
a first knob formed on a first wall of the device, the first knob comprising a first shaft portion and a first head portion; and
a second knob formed on a second wall of the device, the second wall arranged adjacent to the first wall, the second knob comprising a second shaft portion and a second head portion, wherein
the first shaft portion of the first knob is adapted to be received in a keyhole defined in the cross beam of the base station antenna, and
the second shaft portion of the second knob in adapted to be received in a first slot defined in a reflector of the base station antenna.

2. The device as claimed in claim 1, wherein a size of the first head portion is more than a size of the first shaft portion of the first knob.

3. The device as claimed in claim 1, wherein a size of the second head portion is more than a size of the second shaft portion of the second knob.

4. The device as claimed in claim 2, wherein the first head portion of the first knob is defined with a rib.

5. The device as claimed in claim 1, wherein the device comprises a third knob formed on a third wall of the device, the third wall arranged adjacent to the first wall.

6. The device as claimed in claim 5, wherein the second wall and the third wall are interconnected by the first wall to form a unitary structure.

7. The device as claimed in claim 5, wherein the third knob is defined with a third shaft portion and a third head portion, wherein a size of the third head portion is more than a size of the third shaft portion.

8. The device as claimed in claim 7, wherein a length of the third shaft portion of the third knob is more than a length of the second shaft portion of the second knob.

9. The device as claimed in claim 7, wherein a length of each of the second shaft portion and the third shaft portion of the second knob and the third knob, respectively, is at least equal to a thickness of the reflector.

10. The device as claimed in claim 5, wherein at least one of the second wall and the third wall comprises one or more legs extending from the corresponding of the second wall or the third wall of the device, the at least one leg adapted to be received in a second slot defined adjacent to the first slot in the reflector.

11. The device as claimed in claim 1, wherein the device is manufactured by an injection moulding process to have a unitary structure.

12. The device as claimed in claim 1, wherein the device is manufactured from a polymer material having high tensile strength.
